(19) United States
(12) Patent Application Publication
(10) Pub. No.: US 2008/0059198 A1
(43) Pub. Date: Mar. 6, 2008

(54) APPARATUS AND METHOD FOR DETECTING AND REPORTING ONLINE PREDATORS

(75) Inventors: Ariel Maislos, Sunnyvale, CA (US); Ruben Maislos, Or-Yehuda (IL); Eran Arbel, Cupertino, CA (US)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: Pudding Ltd., Kefar-Saba (IL)

(21) Appl. No.: 11/849,374

(22) Filed: Sep. 4, 2007

Related U.S. Application Data
(60) Provisional application No. 60/824,329, filed on Sep. 1, 2006.

(51) Int. Cl. G10L 11/00

(52) U.S. Cl. 704/273

(57) ABSTRACT

A method, apparatus and computer-code is disclosed for detecting predators (i.e. sexual or financial predators) and for reporting and/or blocking access to the detected predators. Electronic media content (i.e. voice content and optionally also video content) or at least one multi-party conversation is monitored and analyzed. At least one predator-handling operation such as reporting the predator and/or blocking access to the predator is carried out.

### CROSS-REFERENCE TO RELATED APPLICATIONS

This patent application claims the benefit of U.S. Provisional Patent Application No. 60/824,329 filed Sep. 1, 2006 by the present inventors.

### FIELD OF THE INVENTION

The present invention relates to techniques for facilitating detecting online predators such as Internet predators and telephone predators.

### BACKGROUND AND RELATED ART

With online activity growing daily, and usage of the Internet and other telecommunications services (for example, cell-phone services) becoming almost universal, there is a concern that these technologies may expose certain users to threats or potential threats. For example, children and adolescents are easily exposed to internet pornography and other adult related material, and may also get harassed by pedophiles who are using the various Internet domains to lure them.

Furthermore, this threat is not limited only to younger users. For example, the office environment has been subject to porn and internet based sexual harassment. In addition, people meet on the internet every day and develop cyber relationships that in some cases turn into actual meetings/dates with potential for success/failure, or in the worst case some date rape.

For the present disclosure, a “predator” is defined as a person who uses the internet, and/or the services available by it and/or other sources of communication (for example, a mobile and/or “ordinary” telephone network, video phone calls, etc) to: (i) Lure children into pedophilic activity (i.e. “pedophilic sexual predator”); and/or (ii) Lure innocent women for date (“non-pedophilic sexual predator”); (iii) Perform scams on innocent people (i.e. “financial predator”).

The following publications provide potentially relevant background material: 20060045082; 20060190419; 20040111479; http//www.castlecops.com/article-6254-nested-0-0.html; http://www.castlecops.com/modules.php?name=News&file=print&sid=6254. All references cited herein are incorporated by reference in their entirety. Citation of a reference does not constitute an admission that the reference is prior art.

### SUMMARY

The present inventors are now disclosing that it is possible to monitor electronic media content of multi-party voice conversations including voice and optionally video (for example, VOIP conversations, mobile phone conversations, landline conversations).

According to presently-disclosed embodiments, one or more multi-party conversations are monitored, and various features are detected (for example, key words may be identified from voice content and/or speech delivery features of how speech is delivered). In the event that the determined features of the electronic media conversation indicate that a given party of the multi-party conversation may be a predator (for example, beyond some defined threshold), one or more “reporting” operations may be carried out (for example, reporting to a parent or law-enforcement official).

It is now disclosed for the first time a method of providing at least one of predator alerting and predator blocking services. The method comprises the steps of: a) monitoring electronic media content of at least one multi-party voice conversation; and b) contingent on at least one feature of the electronic media content indicating a given party of the at least one multi-party conversation is a sexual predator (i.e. in accordance with a classification of the given party as a predator beyond a threshold), effecting at least one predator-protection operation selected from the group consisting of: i) reporting the given party as a predator; ii) blocking access to the given party.

According to some embodiments, the predator-protection operation is contingent on a personality profile, of the electronic media content for the given party, indicating that the given party is a predator.

According to some embodiments, the predator-protection operation is contingent on a personality profile, of the electronic media content for a potential victim conversing with the given party, indicating that the potential victim is a victim.

According to some embodiments, the contingent reporting is contingent on at least one gender-indicative feature of the electronic media content for the given party.

According to some embodiments, the contingent reporting is contingent on at least one age-indicative feature of the electronic media content for the given party.

According to some embodiments, the contingent reporting is contingent on at least one at least one speech delivery feature selected from the group consisting of: a speech tempo feature; a voice tone feature; and a voice inflection feature.

According to some embodiments, the contingent reporting is contingent on a voice print match between the given party and a voice-print database of known predators.

According to some embodiments, the contingent reporting is contingent on a vocabulary deviation feature.

According to some embodiments, i) the monitoring includes monitoring a plurality of distinct conversations; ii) the plurality of conversations includes distinct conversations separated in time by at least one day.

According to some embodiments, the at least one influence feature includes at least one of: A) a person influence feature of the electronic media content; and B) a statement influence feature of the electronic media content.

It is now disclosed for the first time an apparatus for providing at least one of predator alerting and predator blocking services, the apparatus comprising: a) a conversation monitor for monitoring electronic media content of at least one multi-party voice conversation; and b) at least one predator-protection element selected from the group consisting of: i) a predator reporter; and ii) a predator blocker (i.e. for blocking phone and/or internet access to an identified predator—for example, in accordance with telephone number and/or IP and/or voiceprint on the far end of the line), the at least one predator-protection element operative, contingent on at least one feature of the electronic media content indicating given party of the at least one multi-party conversation is a sexual predator, to effect at least one predator-protection operation selected from the group consisting of: i) reporting the given party as a predator; ii) blocking access to the given party.

### BRIEF DESCRIPTION OF THE DRAWINGS

While the invention is described herein by way of example for several embodiments and illustrative drawings, those skilled in the art will recognize that the invention is not limited to the embodiments or drawings described. It should be understood that the drawings and detailed description thereto are not intended to limit the invention to the particular form disclosed, but on the contrary, the invention is to cover all modifications, equivalents and alternatives falling within the spirit and scope of the present invention. As used throughout this application, the word “may” is used in a permissive sense (i.e., meaning “having the potential to’), rather than the mandatory sense (i.e. meaning “must”).

FIG. 1 provides a flow chart of an exemplary technique for handling potential predators in accordance with some embodiments of the present invention.

FIG. 2-3 describe exemplary techniques for determining one of a predator status of a candidate predator and/or a presence or absence of a predator-victim relationship and acting upon the determining in accordance with some embodiments of the present invention.

FIG. 4-12 describe exemplary systems or components thereof for determining one of a predator status of a candidate predator and/or a presence or absence of a predator-victim relationship and acting upon the determining in accordance with some embodiments of the present invention.

### DETAILED DESCRIPTION OF EMBODIMENTS

The present invention will now be described in terms of specific, example embodiments. It is to be understood that the invention is not limited to the example embodiments disclosed. It should also be understood that not every feature of the presently disclosed apparatus, device and computer-readable code for detecting and/or reporting online and/or phone predators is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

The present disclosure relates to “online predators”—the term online predators relates to predators (i.e. sexual predators) that communicate using “voice” (for example, via telephone or Internet VOIP including audio and optionally also video).

The present inventors are now disclosing that it is possible to monitor electronic media content of multi-party voice conversations including voice and optionally video (for example, VOIP conversations, mobile phone conversations, landline conversations). As used herein, ‘providing’ of media or media content includes one or more of the following: (i) receiving the media content (for example, at a server cluster comprising at least one cluster, for example, operative to analyze the media content and/or at a proxy); (ii) sending the media content; (iii) generating the media content (for example, carried out at a client device such as a cell phone and/or PC); (iv) intercepting; and (v) handling media content, for example, on the client device, on a proxy or server.

As used herein, a ‘multi-party’ voice conversation includes two or more parties, for example, where each party communicated using a respective client device including but not limited to desktop, laptop, cell-phone, and personal digital assistant (PDA).

In one example, the electronic media content from the multi-party conversation is provided from a single client device (for example, a single cell phone or desktop). In another example, the media from the multi-party conversation includes content from different client devices.

Similarly, in one example, the media electronic media content from the multi-party conversation is from a single speaker or a single user. Alternatively, in another example, the media electronic media content from the multi-party conversation is from multiple speakers.

The electronic media content may be provided as streaming content. For example, streaming audio (and optionally video) content may be intercepted, for example, as transmitted a telecommunications network (for example, a packet switched or circuit switched network). Thus, in some embodiments, the conversation is monitored on an ongoing basis during a certain time period.

Alternatively or additionally, the electronic media content is pre-stored content, for example, stored in any combination of volatile and non-volatile memory.

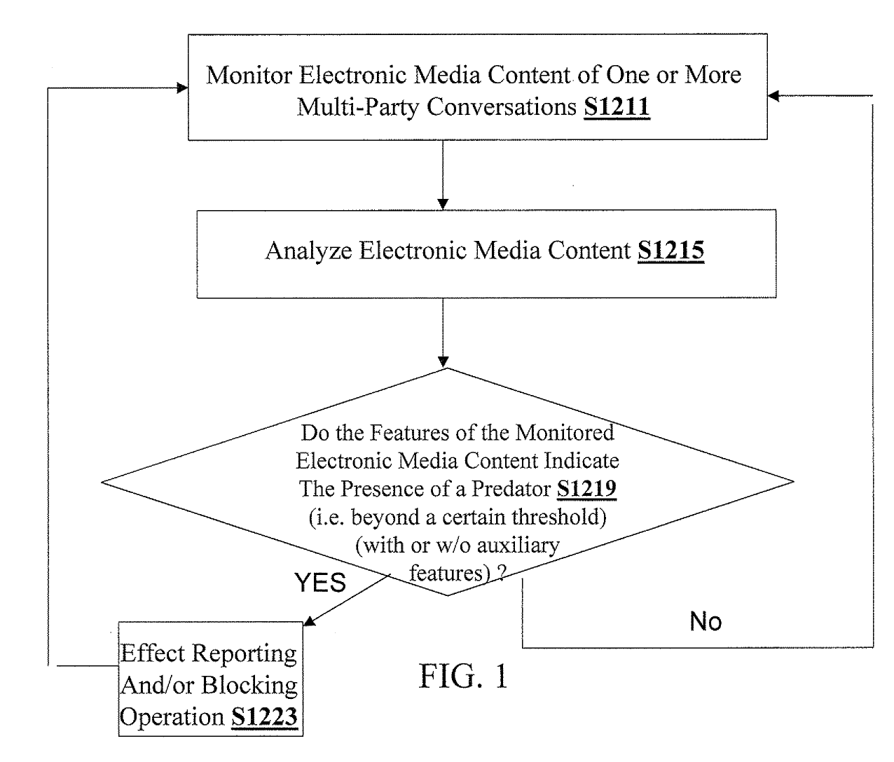

FIG. 1 provides a flow diagram of an exemplary routine for monitoring multi-party conversation(s) and conditionally reporting a given party of the multi-party conversation as a predator in accordance with the electronic media content of the monitored multi-party conversation(s).

In the example of FIG. 1, the technique includes four steps: (i) monitoring S1211 multi-party conversations—for example, voice conversations transmitted over a phone connection or VOIP connections are monitored by “eavesdropping” on the conversations (where permissible by law); (ii) analyzing S1215 electronic media content (i.e. including voice content and optionally video content) of the one or more multi-party conversations (for example, by computing one or more features) (iii) determining S1219 (for example, in accordance with the computed features of the electronic media content and optionally in accordance with additional “auxiliary” features) if a given party of or participant in the conversation is a “predator”; and (iv) in the event of a positive determination S1223, effecting one or more “reporting operations” carried out.

Several use cases for each of these steps are now described. It is recognized that not every feature of every use case is required.

### Use Case 1

According to this use case, a parent or guardian or other “authorized party” may “register” a given client terminal device (for example, a cellphone) or telephone number or VOIP account (for example, a Skype account) to be monitored. In accordance with this non-limiting example, electronic media content on this registered client terminal device or line or VOIP account is monitored over a period of time, and the reporting S1223 includes sending an alert to the “authorized party.”

In this example, the parent or other “authorized party” can configure the system for example via a web interface. For example, the “authorized party” may provide a “white list” of destination phone numbers or VOIP accounts (i.e. numbers with which the registered, monitored device or line or account can carry on a conversation) that are considered “safe” (for example, the phone number of the parents or grandparents, the phone number of a best friend, etc). This could reduce the incidence rate of “false positives” reportings of predators (i.e. it is assumed in this example that the parent or grandparent of the “monitored party” is not a predator).

In another variation, if the system reports an individual as a predator for any reason and the authorized party “knows” with certainty, the authorized party may add the reported individual (for example, his voice print or phone number) via the web interface to the “white list database” in order to avoid “repeat false positives.”

In another example, an individual is reported as a predator only if it is estimated that the individual is a predator with a certainty that exceeds a pre-defined threshold—the higher the threshold, the more false negatives, the lower the threshold, the more false positives. According to this example, the “authorized party” may define or configure the threshold (i.e. either explicitly or implicitly) which needs to be cleared in order to issue a report or alert of someone as a predator.

The combination of the “manual reporting” white list approach together with “automatically” attempting to locate predators by analyzing S1215 electronic media may reduce the incident rate for false positives.

There a number of business scenarios for arranging to monitor a user and/or phone line and/or VOIP account and/or handset. In one example, a telecommunications carrier offers a “predator alert” functionality to subscribers as an add-on service. In one scenario, this service is marketed to parents when purchasing (i) a cellphone plane for their children or adolescents and/or (ii) a landline subscription plan.

In another example related to “white lists,” two or more parents or guardians are needed to authorize adding a person to a white list in case one of the parents or guardians are predators.

### Use Case 2

According to this example, an attempt is made to determine the gender and the age of the “destination speaker” (i.e. with whom the “monitored speaker” for example, an 11 year old girl—on the “monitored line” or “monitored handset” or “monitored VOIP account” is speaking). According to this example, in the event that the “destination speaker” with whom the “monitored party” is speaking is a male is his 30's (i.e. according to appropriate feature calculation), an alert is sent to the “authorized party” (for example, the 11 year old girl's parent or legal guardian).

Of course, not every “strange older mate” is an online and/or telephone predator, and thus in some embodiments, “negative features” indicating that the destination speaker is less likely to be a predator are incorporated.

### Use Case 3

According to this use case, the electronic media content of one or more multi-party is analyzed S1215, and speech content features and speech delivery features are determined. It is possible to assess the age and/or gender of the “destination speaker” (i.e. who is a candidate for identification as a predator) according to any combination of speech content and/or speech content features:

A) Speech content features—after effecting the appropriate speech recognition operations to determine the identity of spoken words, the text may be analyzed for the presence of certain words or phrases. This may be predicated, for example, on the assumption that teenagers use certain slang or idioms unlikely to be used by older members of the population (and vice-versa).

B) Speech delivery features—in one example, one or more speech delivery features such as the voice pitch or speech rate (for example, measured in words/minute) of a child and/or adolescent may be different than and speech delivery features of an young adult or elderly person.

The skilled artisan is referred to, for example, US 20050286705, incorporated herein by reference in its entirety, which provides examples of certain techniques for extracting certain voice characteristics (e.g. language/dialect/accent, age group, gender).

According to this example, the presence of these features are used to help determine the age of the “destination speaker.” In the event that the age and/or gender of the “destination speaker” is deemed “inappropriate” or “likely to be a predator,” the appropriate alert or report is generated.

### Use Case 4

Optionally, the monitored “voice” conversation is also a video conversation.

In this example which relates to video conversations, the physical appearance of the “destination speaker” or party can also be indicative of a destination speaker's age and/or gender. For example, gray hair may indicate an older person, facial hair may indicate a male, etc.

According to this example, the presence of these features are used to help determine the age of the “destination speaker.” In the event that the age and/or gender of the “destination speaker” is deemed “inappropriate” or “likely to be a predator,” the appropriate alert or report is generated.

### Use Case 5

According to this example, a plurality of voice conversations are monitored, and over time, it is possible to compute with a greater accuracy (i.e. as more data for analysis S1215)—the system “learns.”

In one example, after a certain number of conversations (for example, 3 conversations), it is determined with a first “accuracy” that a “target party” or “destination party” is a predator. At this stage, an alert is sent to a child's parent or guardian.

After additional conversations (i.e. after more data is analyzed S1215 and the system “learns”, it is determined with a greater certainty that this same “target party” is a predator, and a similar alert is issued to law enforcement authorities.

Thus, in some implementations, the system may record, analyze and aggregate the user's detected classification profile over a period time and builds a personality profile. The system may then keep monitoring the users patterns, and be alert for the report criteria. The database can also have a global aspect, updated by user reports, and profiles created by the various clients in order to increase the users protection.

### Use Case 6

According to this use case, certain “positive features” and “negative features” are calculated when analyzing the electronic media content S1215. If the positive features “outweigh” the negative features (i.e. according to some metric, defined, for example, according to some “training set” using a supervised and/or unsupervised learning technique), then the appropriate report or alert is generated.

### Use Case 7—Some “Positive” Features

Below is a non-exhaustive list of positive features.

According to one “positive feature,” if the destination conversation party (i.e. the “potential predator party”) requests that the “potential victim party” (for example, the 11 year old owner of the cellphone) meet in a certain location—i.e. make an appointment.

According to another positive feature, the potential predator party make “many” requests (i.e. in some unit of time, as compared to training sets of “non-predators), in general, from the potential victim party.

According to another positive feature, the potential predator party will attempt to flatter the potential victim party (for example, will say things like “you act much older than your age,” etc.

According to another positive feature, the potential victim party has a tendency to get stressed (for example, beyond a given threshold) when encountering and/or interacting with the potential predator party.

According to another positive feature, the potential victim party has a tendency to get stressed or agitated upon receiving requests from the potential predator party. This “stress” may be measure in a number of ways, including, for example, voice tone, the victim party sweating on the terminal device (for example, the cell phone), by analyzing video content of a video conversation, etc.

According to another positive feature, certain inappropriate or sexually-explicit language is used by the potential predator party, and this may be determined, for example, by a speech recognition engine.

According to another positive feature, the potential predator party has a tendency to lie when speaking to the potential victim party (for example, as determined by some lie detection routine for analyzing electronic media voice and optionally also video content).

According to another positive feature, the “potential victim party” has a tendency to lie when speaking to the potential predator party. Alternatively, the potential victim party has a tendency to lie when speaking to a third party about the potential predator party (for example, a friend or parent).

According to another positive feature, the potential predator party attempts to belittle the potential victim party and/or make the potential victim party feel guilty for not fulfilling a request.

### Use Case 8—Database of Known Predators

According to this use case, data from a database of known predators is compared with data from the analyzed S1215 electronic media content.

One or more of the following features may be compared:
i) Biometric features—for example, “voiceprint” features, appearance features, etc.—when a known predator is handled by the justice system, samples of the predator's voice are entered into a database.
ii) Speech delivery features—for example, speech tempo, speech tone.
iii) Known phone number and/or phone IP address and/or known geographic features.
iv) Language features—for each known predator, a database of preferred speech idioms for this specific predator may be used. It is recognized that some of these features may have only a certain amount of predictive power in general case, but may be very useful in other cases—for example, including but not limited to the situation where a specific person is suspected of contacting a “potential victim.”

### Use Case 9—Additional Features (Both Positive and Negative)

The present inventors recognize that it is possible to combine “electronic media content analysis features”

According to one negative auxiliary feature, if the “destination speaking party” is on the “telephone number” white-list of “trusted destination parties” (or alternatively an IP address for a VOIP conversation) then it is like likely and/or positive to report the “destination speaking party” as a potential predator.

According to another auxiliary feature, if the “potential predator party” is speaking from a telephone number of a known sex offender, then the potential predator party will be reported as a predator.

According to another auxiliary feature, it is possible to determine if the “potential predator party” is speaking from a public telephone. In this case, it may be more likely that the potential predator party is indeed a phone predator.

According to another example, the system may be able to accept user reports of a predator behavior and inserted to the database after validation (for example, changed phone numbers and/or physical appearance changes of known sex offenders). This information may be used for future predator attempts on other innocent victims.

### Use Case 10—Demographic Features

In some examples, demographic features such as educational level may be used to determine if a given potential predator is a predator. For example, a certain potential victim may speak with many people of a given educational level (or any other ethnic parameter), and a “deviation” from this pattern may indicate that a potential predator is a predator.

In one example, a demographic profile of a potential victim is compared with a demographic profile of a potential predator, and deviations may be indicative that the potential predator is indeed a predator.

In another example, a given target potential predator may be monitored in different conversations with different individuals. If, for example, a man in his 30s has a pattern of speaking frequently with different pre-teen girls,this may be indicative that the man in his 30s is a predator.

### Use Case 11—Influence Features

In one example, a potential predator can influence a potential victim to fulfill certain request—for example, to meet, to speak at given times, to agree with statements, etc.

In another example, the potential victim exhibits a pattern of initial resisting one or more requests, while later acquiescing to the one or more requests.

In another example, a potential victim speaks with many of his or her friends. If in conversations with his or her friends the “potential victim” is easily influenced, this could require a heightened vigilance when considering the possibility that the potential victim would enter into a victim-predator relationship. This may, for example, influence the thresholds (i.e. the certainty that a given potential predator is indeed a predator—i.e. the false positives vs. false negative tradeoff) for reporting a potential predator as a predator.

### Use Case 12—Personality Profile Features

In this example, one or more personality profiles are generated for the potential victim and/or potential predator. These personality profiles may be indicative of the presence or absence of a predator-victim relationship and/or indicative that a potential or candidate predator is a predator.

### Discussion of S1215

In some embodiments, analysis of electronic media content S1215 includes computing at least one feature of the electronic media content.

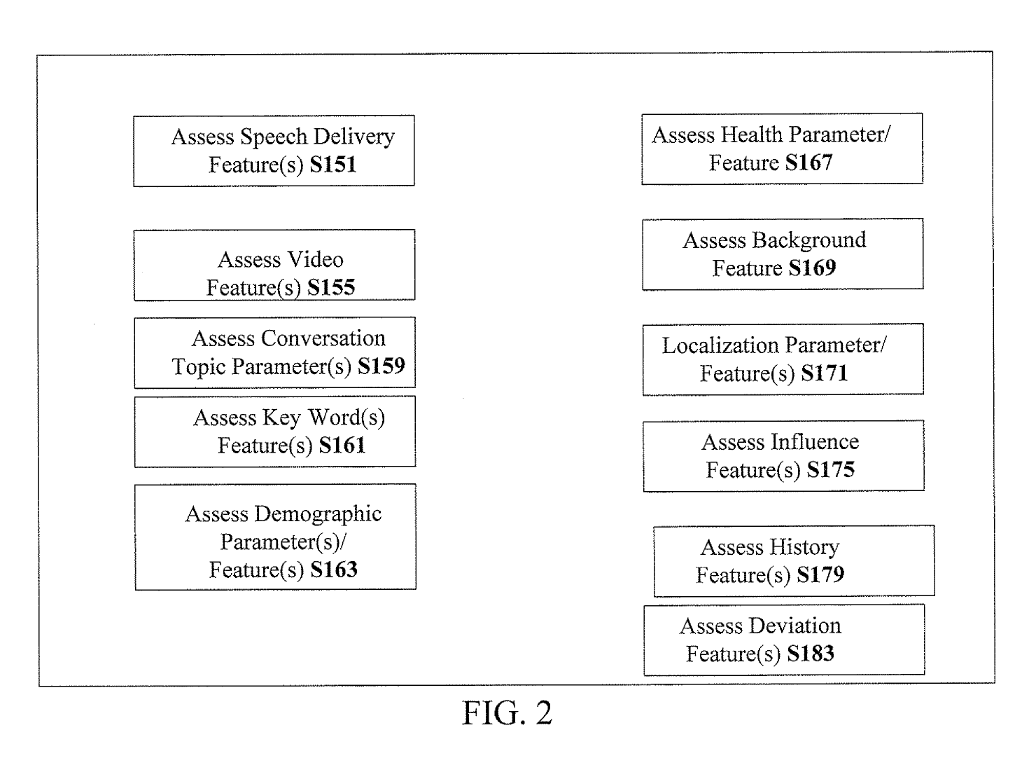

FIG. 2 provides a description of exemplary features, one of more which may be computed in exemplary embodiments.

These features include but are not limited to speech delivery features S151, video features S155, conversation topic parameters or features S159, key word(s) feature S161, demographic parameters or features S163, health or physiological parameters of features S167, background features S169, localization parameters or features S175, influence features S175, history features S179, and deviation features S183.

Thus, in some embodiments, by analyzing and/or monitoring a multi-party conversation (i.e. voice and optionally video), it is possible to assess (i.e. determine and/or estimate) S163 if a conversation participant is a member of a certain demographic group from a current conversation and/or historical conversations.

Relevant demographic groups include but are not limited to: (i) age; (ii) gender; (iii) educational level; (iv) household income; (v) medical condition.

In one example, is a “potential victim” and the “potential predators” are from “unacceptably different” demographic groups, this may, in some circumstances, increase the assessed likelihood that a given individual is a potential predator.

(i) age/(ii) gender—in some embodiments, the age of a conversation participant is determined in accordance with a number of features, including but not limited to one or more of the following: speech content features and speech delivery features.
A) Speech content features—after converting voice content into text, the text may be analyzed for the presence of certain words or phrases. This may be predicated, for example, on the assumption that teenagers use certain slang or idioms unlikely to be used by older members of the population (and vice-versa).
B) Speech delivery features—in one example, one or more speech delivery features such as the voice pitch or speech rate (for example, measured in words/minute) of a child and/or adolescent may be different than and speech delivery features of an young adult or elderly person.

The skilled artisan is referred to, for example, US 20050286705, incorporated herein by reference in its entirety, which provides examples of certain techniques for extracting certain voice characteristics (e.g. language/dialect/accent, age group, gender).

In one example related to video conversations, the user's physical appearance can also be indicative of a user's age and/or gender. For example, gray hair may indicate an older person, facial hair may indicate a male, etc.

These computed features may be useful for estimating a likelihood that a candidate predator is indeed a predator.

(ii) educational level—in general, more educated people (i.e. college educated people) tend to use a different set of vocabulary words than less educated people.

(iv) household income—certain audio and/or visual clues may provide an indication of a household income. For example, a video image of a conversation participant may be examined, and a determination may be made, for example, if a person is wearing expensive jewelry, a fur coat or a designer suit.

In another example, a background video image may be examined for the presence of certain products that indicate wealth. For example, images of the room furnishing (i.e. for a video conference where one participant is ‘at home’) may provide some indication.

In another example, the content of the user's speech may be indicative of wealth or income level. For example, if the user speaks of frequenting expensive restaurants (or alternatively fast-food restaurants) this may provide an indication of household income.

In another example, if a potential victim is from a “lower middle class” socioeconomic group, and the potential predator displays wealth and offers to buy presents for the potential victim, this may increase the likelihood that the potential predator is indeed a predator.

(v) medical condition—In some embodiments, a user's medical condition (either temporary or chronic) may be assessed in accordance with one or more audio and/or video features.

In one example, breathing sounds may be analyzed, and breathing rate may be determined. This may be indicative, for example, of whether or not a potential predator or victim is lying and/or may be indicative of whether or not a potential victim or predator is nervous.

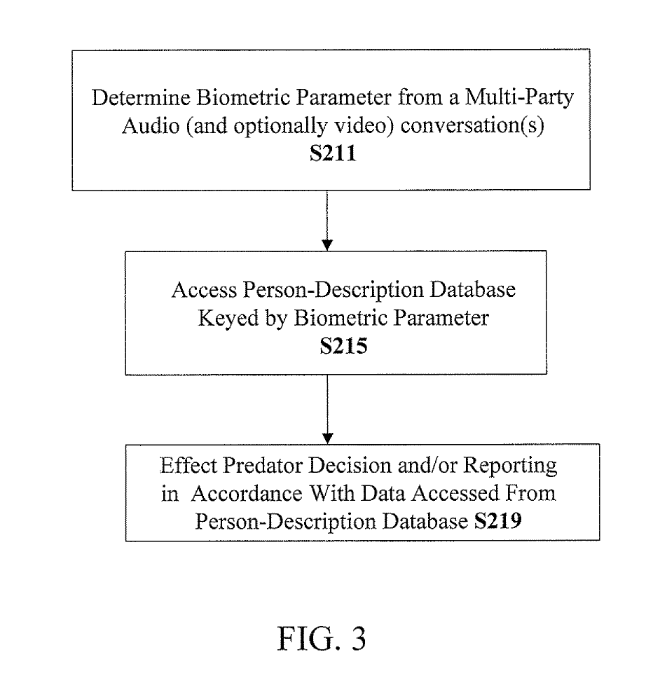

### Storing Biometric Data (For Example, Voice-Print Data) and Demographic Data (with Reference to FIG. 3)

Sometimes it may be convenient to store data about previous conversations and to associate this data with user account information. Thus, the system may determine from a first conversation (or set of conversations) specific data about a given user with a certain level of certainty.

Later, when the user engages in a second multi-party conversation, it may be advantageous to access the earlier-stored demographic data in order to provide to a more accurate assessment if a given “potential predator” is indeed a predator. Thus, there is no need for the system to re-profile the given user.

In another example, the earlier personality and/or demographic and/or “predator candidate” profile may be refined in a later conversation by gathering more ‘input data points.’

In some embodiments, it may be advantageous to maintain a ‘voice print’ database which would allow identifying a given user from his or her ‘voice print.’ For example, if a potential predator speaks with the potential victim over several conversations, a database of voiceprints previous parties with the potential victim has spoken may be maintained, and content associated with the particular speaker stored and associated with an identifier of the previous speaker.

Recognizing an identity of a user from a voice print is known in the art—the skilled artisan is referred to, for example, US 2006/0188076; US 2005/0131706; US 2003/0125944; and US 2002/0152078 each of which is incorporated herein by reference in entirety

Thus, in step S211 content (i.e. voice content and optionally video content) if a multi-party conversation is analyzed and one or more biometric parameters or features (for example, voice print or face ‘print’) are computed. The results of the analysis and optionally personality data and/or “predator indicators” are stored and are associated with a user identity and/or voice print data.

During a second conversation, the identity of the user is determined and/or the user is associated with the previous conversation using voice print data based on analysis of voice and/or video content S215. At this point, the previous demographic information of the user is available.

Optionally, the demographic profile is refined by analyzing the second conversation.

In accordance with demographic data, one or more operations related to identifying and/or reporting potential predators is then carried out S219.

### Discussion of Exemplary Apparatus

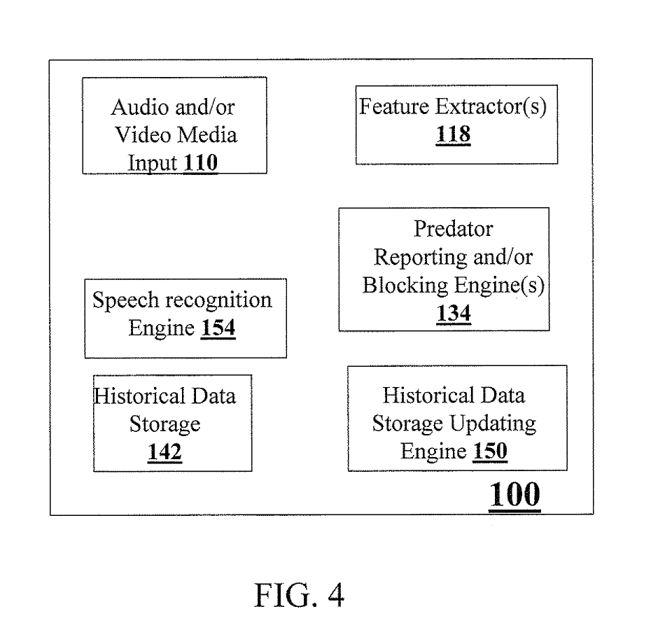

FIG. 4 provides a block diagram of an exemplary system 100 for assessing a likelihood that a potential predator is a predator and/or reporting a likelihood that a potential predator is a predator and/or the activity of the potential predator in according with some embodiments of the present invention. The apparatus or system, or any component thereof may reside on any location within a computer network (or single computer device)—i.e. on the client terminal device 10, on a server or cluster of servers (not shown), proxy, gateway, etc. Any component may be implemented using any combination of hardware (for example, non-volatile memory, volatile memory, CPUs, computer devices, etc) and/or software—for example, coded in any language including but not limited to machine language, assembler, C, C++, Java, C#, Perl etc.

The exemplary system 100 may an input 110 for receiving one or more digitized audio and/or visual waveforms, a speech recognition engine 154 (for converting a live or recorded speech signal to a sequence of words), one or more feature extractor(s) 118, Predator Reporting and/or Blocking Engine(s) 134, a historical data storage 142, and a historical data storage updating engine 150.

Exemplary implementations of each of the aforementioned components are described below.

It is appreciated that not every component in FIG. 4 (or any other component described in any figure or in the text of the present disclosure) must be present in every embodiment. Any element in FIG. 4, and any element described in the present disclosure may be implemented as any combination of software and/or hardware. Furthermore, any element in FIG. 4 and any element described in the present disclosure may be either reside on or within a single computer device, or be a distributed over a plurality of devices in a local or wide-area network.

### Audio and/or Video Input 110

In some embodiments, the media input 110 for receiving a digitized waveform is a streaming input. This may be useful for ‘eavesdropping’ on a multi-party conversation in substantially real time. In some embodiments, ‘substantially real time’ refers to refer time with no more than a pre-determined time delay, for example, a delay of at most 15 seconds, or at most 1 minute, or at most 5 minutes, or at most 30 minutes, or at most 60 minutes.

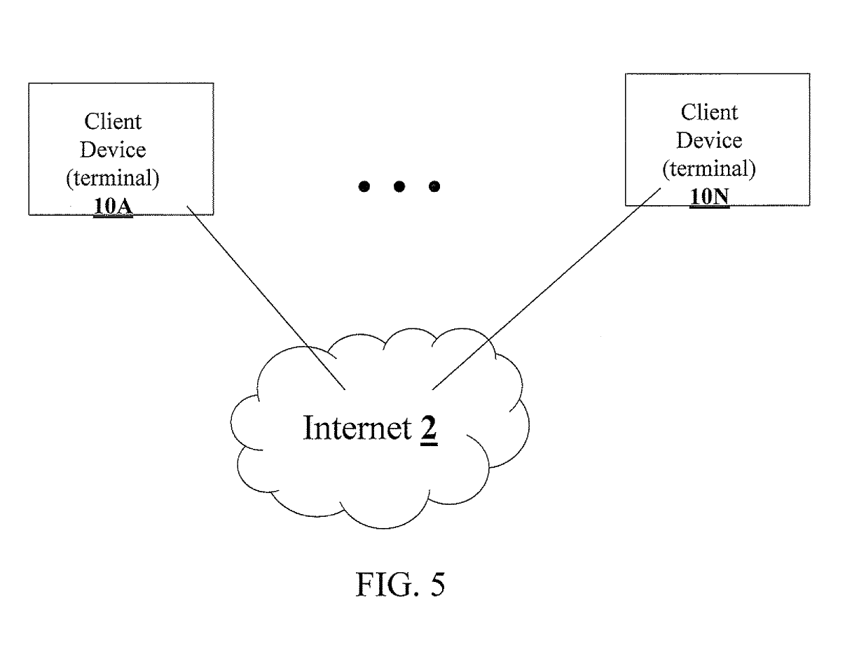

FIG. 5, a multi-party conversation is conducted using client devices or communication terminals 10 (i.e. N terminals, where N is greater than or equal to two) via the Internet 2. In one example, VOIP software such as Skype® software resides on each terminal 10.

In one example, ‘streaming media input’ 110 may reside as a ‘distributed component’ where an input for each party of the multi-party conversation resides on a respective client device 10. Alternatively or additionally, streaming media signal input 110 may reside at least in part ‘in the cloud’ (for example, at one or more servers deployed over wide-area and/or publicly accessible network such as the Internet 20). Thus, according to this implementation, and audio streaming signals and/or video streaming signals of the conversation (and optionally video signals) may be intercepted as they are transmitted over the Internet.

In yet another example, input 110 does not necessarily receive or handle a streaming signal. In one example, stored digital audio and/or video waveforms may be provided stored in non-volatile memory (including but not limited to flash, magnetic and optical media) or in volatile memory.

It is also noted, with reference to FIG. 5, that the multi-party conversation is not required to be a VOIP conversation. In yet another example, two or more parties are speaking to each other in the same room, and this conversation is recorded (for example, using a single microphone, or more than one microphone). In this example, the system 100 may include a ‘voice-print’ identifier (not shown) for determining an identity of a speaking party (or for distinguishing between speech of more than one person). In yet another example, at least one communication device is a cellular telephone communicating over a cellular network.

In yet another example, two or more parties may converse over a ‘traditional’ circuit-switched phone network, and the audio sounds may be streamed to predator detection and handling system 100 and/or provided as recording digital media stored in volatile and/or non-volatile memory.

### Feature Extractor(s) 118

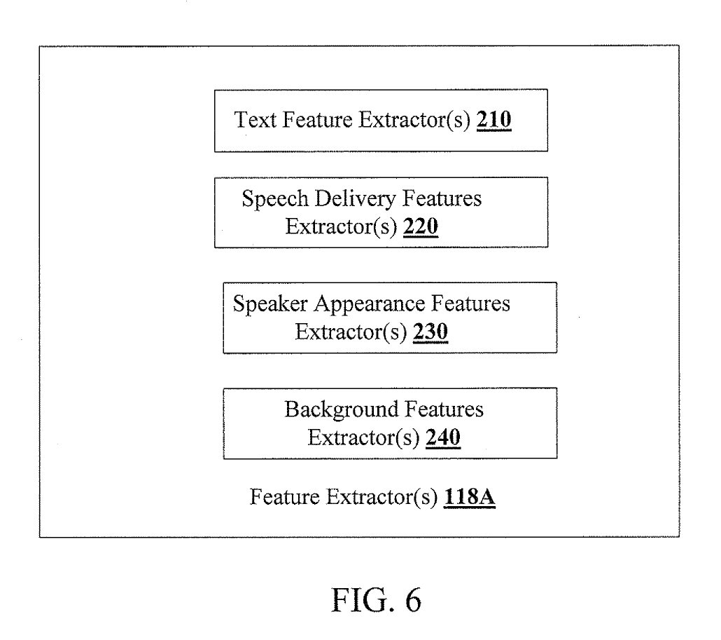

FIG. 6 provides a block diagram of several exemplary feature extractor(s) this is not intended as comprehensive but just to describe a few feature extractor(s). These include: text feature extractor(s) 210 for computing one or more features of the words extracted by speech recognition engine 154 (i.e. features of the words spoken); speech delivery features extractor(s) 220 for determining features of how words are spoken; speaker visual appearance feature extractor(s) 230 (i.e. provided in some embodiments where video as well as audio signals are analyzed ); and background features (i.e. relating to background sounds or noises and/or background images).

It is noted that the feature extractors may employ any technique for feature extraction of media content known in the art, including but not limited to heuristically techniques and/or ‘statistical AI’ and/or ‘data mining techniques’ and/or ‘machine learning techniques’ where a training set is first provided to a classifier or feature calculation engine. The training may be supervised or unsupervised.

Exemplary techniques include but are not limited to tree techniques (for example binary trees), regression techniques, Hidden Markov Models, Neural Networks, and meta-techniques such as boosting or bagging. In specific embodiments, this statistical model is created in accordance with previously collected “training” data. In some embodiments, a scoring system is created. In some embodiments, a voting model for combining more than one technique is used.

Appropriate statistical techniques are well known in the art, and are described in a large number of well known sources including, for example, Data Mining: Practical Machine Learning Tools and Techniques with Java Implementations by Ian H. Witten, Eibe Frank; Morgan Kaufmann, October 1999), the entirety of which is herein incorporated by reference.

It is noted that in exemplary embodiments a first feature may be determined in accordance with a different feature, thus facilitating ‘feature combining.’

In some embodiments, one or more feature extractors or calculation engine may be operative to effect one or more ‘classification operations’—e.g. determining a gender of a speaker, age range, ethnicity, income, and many other possible classification operations.

Each element described in FIG. 6 is described in further detail below.

Text Feature Extractor(s) 210

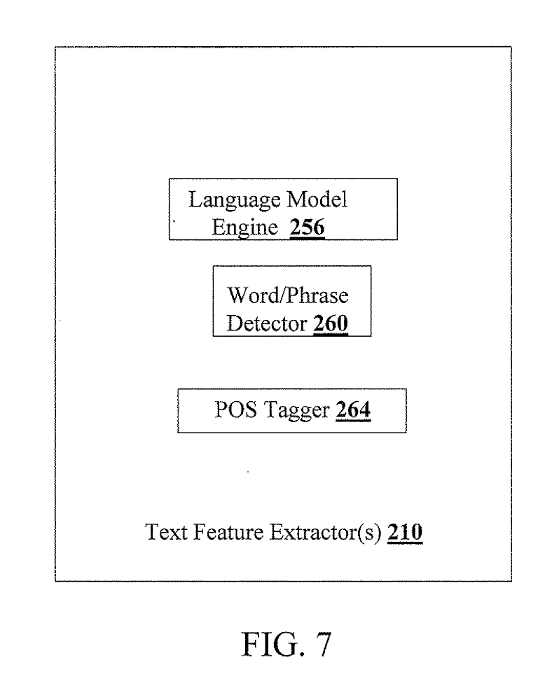

FIG. 7 provides a block diagram of exemplary text feature extractors. Thus, certain phrases or expressions spoken by a participant in a conversation may be identified by a phrase detector 260.

In one example, when a speaker uses a certain phrase, this may be indicative of a potential predator. For example, if a predator says uses sexually explicit language and/or requests favors of the potential victim, this may be a sign that the potential predator is more likely to be a predator.

In another example, a speaker may use certain idioms that indicate general personality and/or personality profile rather than a desire at a specific moment. These phrases may be detected and stored as part of a speaker profile, for example, in historical data storage 142.

The speaker profile built from detecting these phrases, and optionally performing statistical analysis.

The phrase detector 260 may include, for example, a database of pre-determined words or phrases or regular expressions—for example, related to deception and/or sexually explicit phrases.

In another example, the text feature extractor(s) 210 may be used to provide a demographic profile of a given speaker. For example, usage of certain phrases may be indicative of an ethnic group of a national origin of a given speaker (where permitted by law). As will be described below, this may be determined using some sort of statistical model, or some sort of heuristics, or some sort of scoring system.

In some embodiments, it may be useful to analyze frequencies of words (or word combinations) in a given segment of conversation using a language model engine 256.

For example, it is recognized that more educated people tend to use a different set of vocabulary in their speech than less educated people. Thus, it is possible to prepare pre-determined conversation ‘training sets’ of more educated people and conversation ‘training sets’ of less educated people. For each training set, frequencies of various words may be computed. For each pre-determined conversation ‘training set,’ a language model of word (or word combination) frequencies may be constructed.

According to this example, when a segment of conversation is analyzed, it is possible (i.e. for a given speaker or speakers) to compare the frequencies of word usage in the analyzed segment of conversation, and to determine if the frequency table more closely matches the training set of more educated people or less educated people, in order to obtain demographic data (i.e.

This principle could be applied using pre-determined ‘training sets’ for native English speakers vs. non-native English speakers, training sets for different ethnic groups, and training sets for people from different regions.

This principle may also be used for different conversation ‘types.’ For example, conversations related to computer technologies would tend to provide an elevated frequency for one set of words, romantic conversations would tend to provide an elevated frequency for another set of words, etc. Thus, for different conversation types, or conversation topics, various training sets can be prepared. For a given segment of analyzed conversation, word frequencies (or word combination frequencies) can then be compared with the frequencies of one or more training sets.

In one example, a potential predator is a relative of potential victim, and a conversation of certain topics (for example, sexually explicitly and/or an agreement to meet somewhere, etc) are associated with “topic deviations” that are indicative of predatory behavior.

The same principle described for word frequencies can also be applied to sentence structures—i.e. certain pre-determined demographic groups or conversation type may be associated with certain sentence structures. Thus, in some embodiments, a part of speech (POS) tagger 264 is provided.

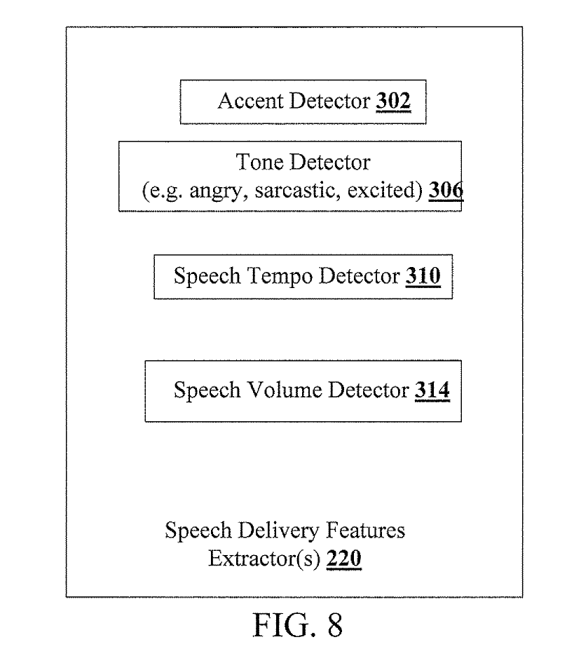

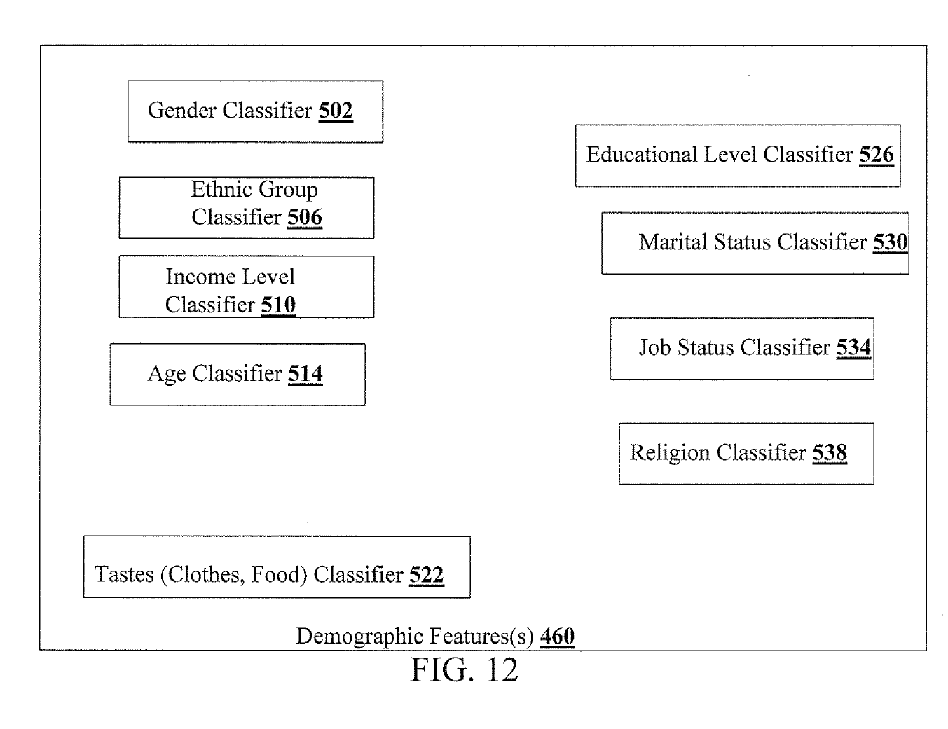

### A Discussion of FIGS. 8-12

FIG. 8 provides a block diagram of an exemplary system 220 for detecting one or more speech delivery features. This includes an accent detector 302, tone detector 306, speech tempo detector 310, and speech volume detector 314 (i.e. for detecting loudness or softness.

As with any feature detector or computation engine disclosed herein, speech delivery feature extractor 220 or any component thereof may be pre-trained with ‘training data’ from a training set.

FIG. 8 provides a block diagram of an exemplary system 230 for detecting speaker appearance features—i.e. for video media content for the case where the multi-party conversation includes both voice and video. This includes a body gestures feature extractor(s) 352, and physical appearance features extractor 356.

In one example, the potential predator stares at the potential victim in a lecherous manner—this body gesture may be indicative of a potential predator.

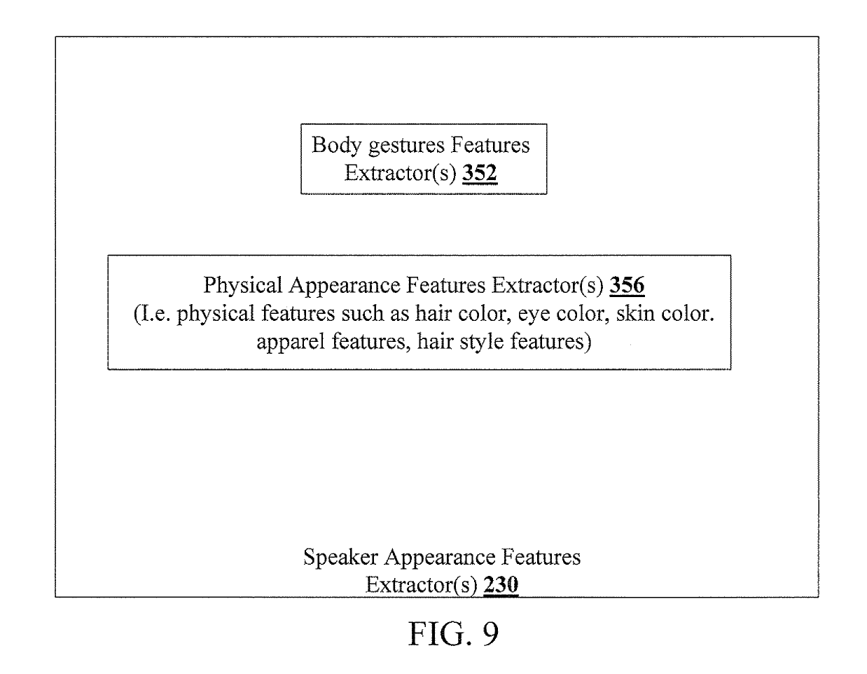

FIG. 9 provides a block diagram of an exemplary background feature extractor(s) 250. This includes (i) audio background features extractor 402 for extracting various features of background sounds or noise including but not limited to specific sounds or noises such as pet sounds, an indication of background talking, an ambient noise level, a stability of an ambient noise level, etc; and (ii) visual background features extractor 406 which may, for example, identify certain items or features in the room, for example, certain sex toys or other paraphernalia a room.

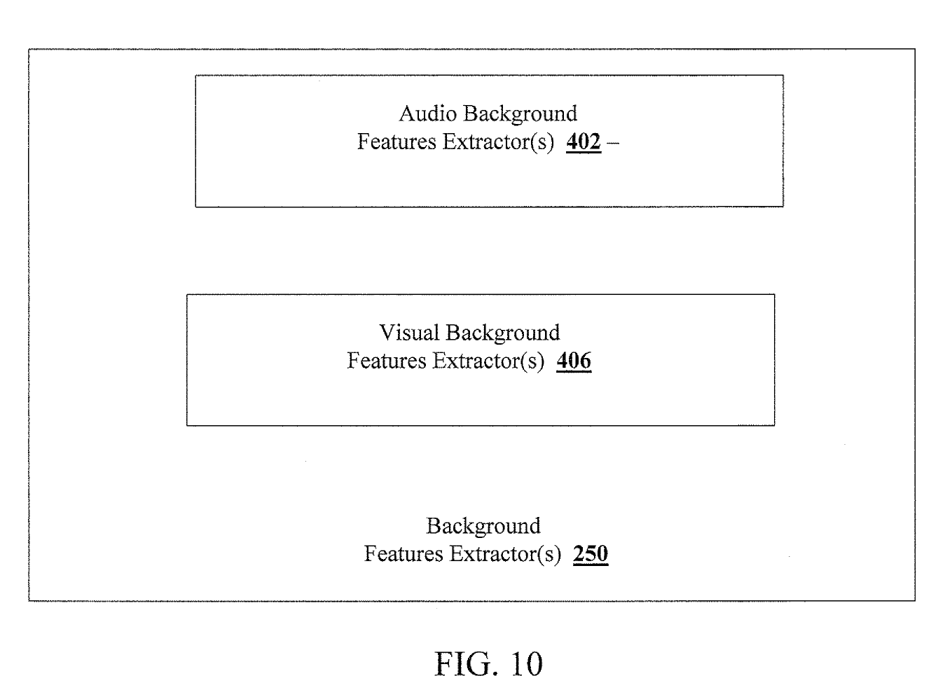

FIG. 10 provides a block diagram of an additional feature extractors 118 for determining one or more features of the electronic media content of the conversations. Certain features may be ‘combined features’ or ‘derived features’ derived from one or more other features.

This includes a conversation harmony level classifier (for example, determining if a conversation is friendly or unfriendly and to what extent) 452, a deviation feature calculation engine 456, a feature engine for demographic feature(s) 460, a feature engine for physiological status 464, a feature engine for conversation participants relation status 468 (for example, family members, business partners, friends, lovers, spouses, etc), conversation expected length classifier 472, conversation topic classifier 476, etc.

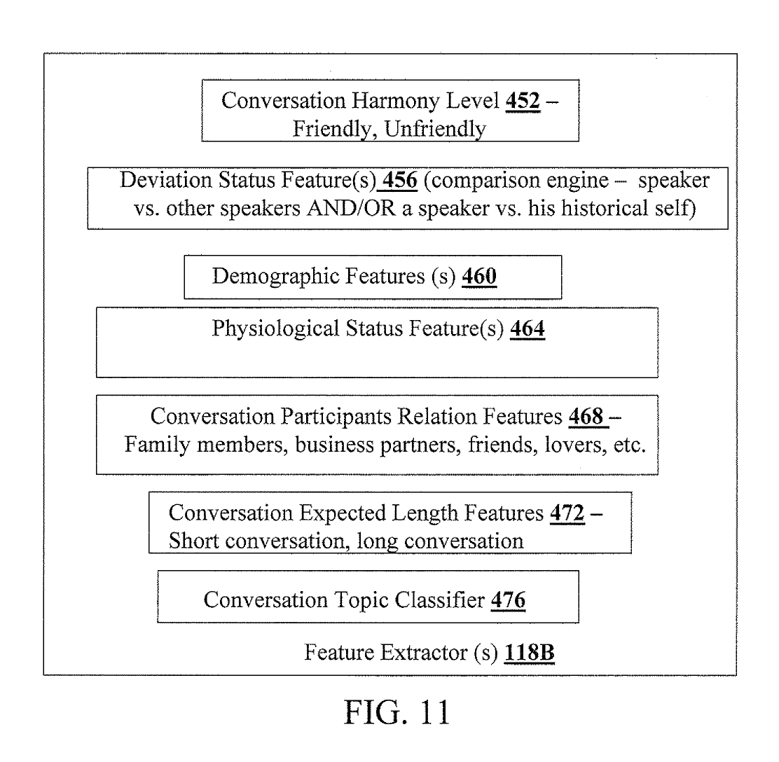

FIG. 11 provides a block diagram of exemplary demographic feature calculators or classifiers. This includes gender classifier 502, ethnic group classifier 506, income level classifier 510, age classifier 514, national/regional origin classifier 518, tastes (for example, clothes and good) classifier 522, educational level classifier 5267, marital status classifier 530, and job status classifier 534 (i.e. employed vs. unemployed, manager vs. employee, etc

### Discussion of S1223 of FIG. 1

### Reporting and/or Counteractivity

In some embodiments, the system then dynamically classifies the near end user (i.e. the potential victim) and/or the far end users (i.e. the potential predator) compiles a report, and if the classification meets a certain criteria, it can either disconnect or block electronic content, or even page a supervisor in any form, including but not limited to e-mail, SMS or synthesized voice via phone call.

In some embodiments, the report may include stored electronic media content of the multi-party conversation(s) as “evidence” for submission in a court of law (where permitted by law and/or with prior consent).

### A Discussion of Determining a Personality Profile of a Potential Predator and/or Potential Victim

The present inventors are now disclosing that the likelihood that a potential predator is a predator and/or that a potential victim is a victim (i.e. involved in a predator-victim relationship with the potential predator, thereby indicating that the potential predator is a predator) may depend on one or more personality traits of the potential predator and/or potential victim.

In one example, a potential predator is more likely to be bossy and/or angry and/or emotionally unstable.

In another example, a potential victim is more likely to be introverted and/or acquiescent and/or unassertive and/or lacking self confidence.

In a particular example, if the potential victim indicates more of these “victim traits” it may be advantageous to report the “potential predator” as a predator even if there is a “weaker” indication in the potential predator's behavior. Although this may be “unfair” to the potential predator, this could spare the victim the potential tram of being victimized by a predator. In one example, the “potential predator” is more likely to be reported as a predator to monitoring parents or guardians of the potential victim but not necessarily more likely to be reported as a predator to law enforcement authorities.

For the present disclosure, a ‘personality-profile’ refers to a detected (i.e. from the electronic media content) presence or absence of one or more ‘personality traits.’ Typically, each personality trait is determined beyond a given ‘certainty parameter’ (i.e. at least 90% certain, at least 95% certain, etc). This may be carried out using, for example, a classification model for classifying the presence or absence of the personality trait(s), and the ‘personality trait certainty’ parameter may be computed, for example, using some ‘test set’ of electronic media content of a conversation between people of known personality.

The determination of whether or not a given conversation party (i.e. someone participating in the multi-party conversation that generates voice content and optionally video or other audio content) has a given ‘personality trait(s)’ may be carried out in accordance with one or more ‘features’ of the multi-party conversation.

Some features may be ‘positive indicators.’ For example, a given individual may speak loudly, or talk about himself, and these features may be considered positive indicators that the person is ‘extroverted.’ It is appreciated that not every loud-spoken individual is necessarily extroverted. Thus, other features may be ‘negative indicators’ for example, a person's body language (an extroverted person is likely to make eye-contact, and someone who looks down when speaking is less likely to be extroverted—this may be a negative indicator). In different embodiments, the set of ‘positive indicators’ (i.e. the positive feature set) may be “weighed” (i.e. according to a classification model) against a set of ‘negative indicators’ to classify a given individual as ‘having’ or ‘lacking’ a given personality trait, with a given certainty. It is understood that more positive indicators and fewer negative indicators for a given personality trait for an individual would allow a hypothesis that the individual ‘has’ the personality trait to be accepted with a greater certainty or ‘hurdle.’

In another example, a given feature (i.e. feature “A”) is only indicative of a given personality trait (i.e. trait “X”) if the feature appears in combination with a different feature (i.e. feature “B”). Different models designed to minimize the number of false positives and false negatives may require a presence or absence of certain combinations of “features” in order to accept or reject a given personality trait presence or absence hypothesis.

According to some embodiments, the aforementioned personality-profile-dependent providing is contingent on a positive feature set of at least one feature of the electronic media content for the personality profile, outweighing a negative feature set of at least one feature of the electronic media content for the personality profile, according to a training set classifier model.

According to some embodiments, at least one feature of at least one of the positive and the negative feature set is a video content feature (for example, an ‘extrovert’ may make eye contact with a co-conversationalist).

According to some embodiments, at least one feature of at least one of the positive and the negative feature set is a key words feature (for example, a person may say ‘I am angry” or “I am happy”).

According to some embodiments, at least one feature of at least one of the positive and the negative feature set is a speech delivery feature (for example, speech loudness, speech tempo, voice inflection (i.e. is the person a ‘complainer’ or not), etc).

Another exemplary speech delivery feature is a inter-party speech interruption feature—i.e. does an individual interrupt others when they speak or not.

According to some embodiments at least one feature of at least one of the positive and the negative feature set is a physiological parameter feature (for example, a breathing parameter (an exited person may breath faster, or an alcoholic may breath faster when viewing alcohol), a sweat parameter (a nervous person may sweat more than a relaxed person)).

According to some embodiments, at least one feature of at least one of the positive and the negative feature set includes at least one background feature selected from the group consisting of: i) a background sound feature (i.e. an introverted person would be more likely to be in a quiet room on a regular basis); and ii) a background image feature (i.e. a messy person would have a mess in his room and this would be visible in a video conference).

According to some embodiments, at least one feature of at least one of the positive and the negative feature set if selected from the group consisting of: i) a typing biometrics feature; ii) a clicking biometrics feature (for example, a ‘hyperactive person’ would click quickly); and iii) a mouse biometrics feature (for example, one with attention-deficit disorder would rarely leave his or her mouse in one place).

According to some embodiments, at least one feature of at least one of the positive and the negative feature set is an historical deviation feature (i.e. comparing user behavior at one point in time with another point in time—this could determine if a certain behavior is indicative of a transient mood or a user personality trait).

According to some embodiments, at least the historical deviation feature is an intra-conversation historical deviation feature (i.e. comparing user behavior in different conversations—for example, separated in time by at least a day).

According to some embodiments, i) the at least one multi-party voice conversation includes a plurality of distinct conversations; ii) at least one historical deviation feature is an inter-conversation historical deviation feature for at least two of the plurality of distinct conversations.

According to some embodiments, i) the at least one multi-party voice conversation includes a plurality of at least day-separated distinct conversations; ii) at least one historical deviation feature is an inter-conversation historical deviation feature for at least two of the plurality of at least day-separated distinct conversations.

According to some embodiments, at least the historical deviation feature includes at least one speech delivery deviation feature selected from the group consisting of: i) a voice loudness deviation feature; ii) a speech rate deviation feature.

According to some embodiments, at least the historical deviation feature includes a physiological deviation feature (for example, is a user's breathing rate consistent, or are there deviations—an excitable person is more likely to have larger fluctuations in breathing rate).

As noted before, different models for classifying people according to their personalities may examine a combination of features, and in order to reduce errors, certain combinations of features may be required in order to classify a person has “having” or “lacking” a personality trait.

Thus, according to some embodiments, the personality-profile-dependent providing is contingent on a feature set of the electronic media content satisfying a set of criteria associated with the personality profile, wherein: i) a presence of a first feature of the feature set without a second feature the feature set is insufficient for the electronic media content to be accepted according to the set of criteria for the personality profile; ii) a presence of the second feature without the first feature is insufficient for the electronic media content to be accepted according to the set of criteria for the personality profile; iii) a presence of both the first and second features is sufficient (i.e. for classification) according to the set of criteria. In the above example, both the “first” and “second” features are “positive features”—appearance of just one of these features is not “strong enough” to classify the person and both features are required.

In another example, the “first” feature is a “positive” feature and the “second” feature is a “negative” feature. Thus, in some embodiments, the personality-profile-dependent providing is contingent on a feature set of the electronic media content satisfying a set of criteria associated with the personality profile, wherein: i) a presence of both a first feature of the feature set and a second feature the feature set necessitates the electronic media content being rejected according to the set of criteria for the personality profile; ii) a presence of the first feature without the second feature allows the electronic media content to be accepted according to the set of criteria for the personality profile.

It is recognized that it may take a certain amount of minimum time in order to reach meaningful conclusions about a person's personality traits, and distinguish behavior indicative of transient moods with behavior indicative of personality traits. Thus, in some embodiments, i) the at least one multi-party voice conversation includes a plurality of distinct conversations; ii) the first feature is a feature is a first the conversation of the plurality of distinct conversations; iii) the second feature is a second the conversation of the plurality of distinct conversations.

According to some embodiments, i) the at least one multi-party voice conversation includes a plurality of at least day-separated distinct conversations; ii) the first feature is a feature is a first the conversation of the plurality of distinct conversations; iii) the second feature is a second the conversation of the plurality of distinct conversations; iv) the first and second conversations are at least day-separated conversations.

According to some embodiments, the providing electronic media content includes eavesdropping on a conversation transmitted over a wide-range telecommunication network.

According to some embodiments, the personality profile is a long-term personality profile (i.e. derived from a plurality of distinct conversations that transpire over a ‘long’ period of time—for example, at least a week or at least a month).

### A Non-Limiting List of Exemplary Personality Traits

Below is a non-limiting list of various personality traits, each of which may be detected for a given speaker or speakers—in accordance with one or more personality traits, a given individual may be classified as a victim or predator, allowing for predator reporting and/or blocking. In the list below, certain personality traits are contrasted with their opposite, though it is understood that this is not intended as a limitation.
a) Ambitious vs. Lazy
b) Passive vs. active
c) passionate vs. dispassionate
d) selfish vs. selfless
e) Norm Abiding vs. Adventurous
f) Creative or not
g) Risk averse vs. Risk taking
h) Optimist vs Pessimist
i) introvert vs. extrovert
j) thinking vs feeling
k) image conscious or not
l) impulsive or not
m) gregarious/anti-social
n) addictions—food, alcohol, drugs, sex
o) contemplative or not
p) intellectual or not
q) bossy or not
r) hedonistic or not
s) fear-prone or not
t) neat or sloppy
u) honest vs. untruthful

In some embodiments, individual speakers are given a numerical ‘score’ indicating a propensity to exhibiting a given personality trait. Alternatively or additionally, individual speakers are given a ‘score’ indicating a lack of exhibiting a given personality trait.

In the description and claims of the present application, each of the verbs, “comprise” “include” and “have”, and conjugates thereof are used to indicate that the object or objects of the verb are not necessarily a complete listing of members, components, elements or parts of the subject or subjects of the verb.

All references cited herein are incorporated by reference in their entirety. Citation of a reference does not constitute an admission that the reference is prior art.

The articles “a” and “an” are used herein to refer to one or to more than one (i.e., to at least one) of the grammatical object of the article. By way of example, “an element” means one element or more than one element.

The term “including” is used herein to mean, and is used interchangeably with, the phrase “including but not limited” to.

The term “or” is used herein to mean, and is used interchangeably with, the term “and/or,” unless context clearly indicates otherwise.

The term “such as” is used herein to mean, and is used interchangeably, with the phrase “such as but not limited to”.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

What is claimed is:

1) A method of providing at least one of predator alerting and predator blocking services, the method comprising:
a) monitoring electronic media content of at least one multi-party voice conversation; and
b) contingent on at least one feature of said electronic media content indicating given party of said at least one multi-party conversation is a sexual predator, effecting at least one predator-protection operation selected from the group consisting of:
i) reporting said given party as a predator;
ii) blocking access to said given party.

2) The method of claim 1 wherein said predator-protection operation is contingent on a personality profile, of said electronic media content for said given party, indicating that said given party is a predator.

3) The method of claim 1 wherein said predator-protection operation is contingent on a personality profile, of said electronic media content for a potential victim conversing with said given party, indicating that said potential victim is a victim.

4) The method of claim 1 wherein said contingent reporting is contingent on at least one gender-indicative feature of said electronic media content for said given party.

5) The method of claim 1 wherein said contingent reporting is contingent on at least one age-indicative feature of said electronic media content for said given party.

6) The method of claim 1 wherein said contingent reporting is contingent on at least one at least one speech delivery feature selected from the group consisting of:
i) a speech tempo feature;
ii) a voice tone feature; and
iii) a voice inflection feature.

7) The method of claim 1 wherein said contingent reporting is contingent on a voice print match between said given party and a voice-print database of known predators.

8) The method of claim 1 wherein said contingent reporting is contingent on a vocabulary deviation feature.

9) The method of claim 1 wherein:
i) said monitoring includes monitoring a plurality of distinct conversations'
ii) said plurality of conversations includes distinct conversations separated in time by at least one day.

10) The method of claim 1 wherein said at least one said influence feature includes at least one of:
A) a person influence feature of said electronic media content; and
B) a statement influence feature of said electronic media content.

11) An apparatus for providing at least one of predator alerting and predator blocking services, the apparatus comprising:
a) a conversation monitor for monitoring electronic media content of at least one multi-party voice conversation; and
b) at least one predator-protection element selected from the group consisting of:
i) a predator reporter; and
ii) a predator blocker,
said at least one predator-protection element operative, contingent on at least one feature of said electronic media content indicating given party of said at least one multi-party conversation is a sexual predator, to effect at least one predator-protection operation selected from the group consisting of:
i) reporting said given party as a predator;
ii) blocking access to said given party.

12) The apparatus of claim 11 wherein said at least one predator-protection element is operative to effect said predator-protection operation contingent on a personality profile, derivable from said electronic media content, of said given party.

13) The apparatus of claim 11 wherein said at least one predator-protection element is operative to effect said predator-protection operation contingent on a personality profile, derivable from said electronic media content, of a potential victim party that converses with said given party in said at least one multi-party voice conversation.

14) The apparatus of claim 11 wherein said at least one predator-protection element is operative to effect said predator-protection operation contingent on a personality profile, of said electronic media content for said given party, indicating that said given party is a predator.

15) The apparatus of claim 11 wherein said at least one predator-protection element is operative to effect said predator-protection operation contingent on at least one gender-indicative feature of said electronic media content for said given party.

16) The apparatus of claim 11 wherein said at least one predator-protection element is operative to effect said predator-protection operation contingent on at least one age-indicative feature of said electronic media content for said given party.

17) The apparatus of claim 11 wherein said at least one predator-protection element is operative to effect said predator-protection operation contingent on said contingent reporting is contingent on at least one
at least one speech delivery feature selected from the group consisting of:
iii) a speech tempo feature;
iv) a voice tone feature; and
iii) a voice inflection feature.

18) The apparatus of claim 11 wherein said at least one predator-protection element is operative to effect said predator-protection operation contingent on a voice print match between said given party and a voice-print database of known predators.

19) The apparatus of claim 11 wherein said at least one predator-protection element is operative to effect said predator-protection operation contingent on a vocabulary deviation feature.

20) The apparatus of claim 11 wherein:
i) said conversation monitor is operative to monitor a plurality of distinct conversations;
ii) said plurality of conversations includes distinct conversations separated in time by at least one day;
iii) said at least one predator-protection element is operative to effect said predator-protection operation in accordance with electronic media content of said at least one day separated distinct conversations.
